(19) United States
(12) Patent Application Publication
(10) Pub. No.: US 2005/0189729 A1
(43) Pub. Date: Sep. 1, 2005

(54) Method for adjusting and controlling an active suspension

(76) Inventor: Ernst-Ludwig Dorr, Stuttgart (DE)

Correspondence Address: KLAUS J. BACH, 4407 TWIN OAKS DRIVE, MURRYSVILLE, PA, 15668, US

(21) Appl. No.: 11/086,785

(22) Filed: Mar. 22, 2005

Related U.S. Application Data
(63) Continuation-in-part of application No. PCT/EP03/10146, filed on Sep. 12, 2003.

(30) Foreign Application Priority Data
Sep. 24, 2002 (DE) 102 44 363.7

(51) Int. Cl. B60G 17/005

(52) U.S. Cl. 280/5.507

(57) ABSTRACT

In a method of controlling an active wheel suspension for a vehicle having a vehicle body that is supported by four vehicle wheels and a controllable suspension system, which includes displacement elements that can be set by a control unit, with sensors assigned to the control unit for determining spring travels and plunger positions, the control unit determines torsion constellations of the suspension system in which diagonally opposite vehicle wheels—in a compression stage—are on average at a shorter distance from the vehicle body than the wheels on the other diagonal—the rebound diagonal—and compensates for these torsion constellations by at least one of retracting the displacement elements on the compression diagonal and extending the displacement elements on the rebound diagonal.

This is a Continuation-In-Part Application of International Application PCT/EP2003/01046 filed Sep. 12, 2003 and claiming the priority of German application 102 44 363.7 filed Sep. 24, 2002.

### BACKGROUND OF THE INVENTION

The invention relates to a method for adjusting and/or controlling an active wheel suspension in a motor vehicle having a vehicle body supported by four vehicle wheels by passive spring elements and hydraulic displacement units and a control units for controlling the hydraulic displacement units.

The design of a chassis is of considerable importance to improving the comfort of travel in passenger vehicles and/or trucks. This requires high-performance suspension and/or damping systems as components of the chassis. In principle, a distinction is drawn between passive and active chassis when designing chassis.

In the passive chassis that have predominantly been utilized hitherto, the spring and/or damping systems used as suspension systems for the vehicle wheels have tended to be designed to be relatively hard (sporty) or relatively soft (comfortable), depending on the intended use of the vehicle. With these systems, it is not possible to influence the chassis characteristics or the spring and/or damping systems while driving.

In the case of active chassis, on the other hand, actuators which can be used to apply forces between the vehicle body and the wheels when driving as a function of the driving situation are fitted between a vehicle body and the vehicle wheels. As a result, the chassis characteristics and therefore the handling of the chassis as a whole can be influenced, in each case appropriately for the current operating state and as part of a control or adjustment configuration.

DE 43 03 160 A1 discloses a system for adjusting and/or controlling a chassis, in which at least one actuator is fitted as a suspension system between the vehicle body and at least one vehicle wheel. To apply forces between the vehicle body and the wheel by means of the actuator, there are adjustment and/or control means, which act on the actuator as a function of variables which represent and/or influence the driving state of the vehicle. The adjustment and/or control means in this case comprise at least two control and/or adjustment blocks for controlling and/or adjusting various properties of the vehicle which influence the driving behavior of the vehicle. Furthermore, the control and/or adjustment means can be switched on and off.

DE 199 12 898 C1 discloses a stress adjustment arrangement for a motor vehicle that has a body supported by four wheels, with in each case two wheels located diametrically opposite one another forming a diagonal pair of wheels. A stress adjustment arrangement of this type is designed in such a way that it has a simple structure and ensures rapid adjustment. For this purpose, each wheel is assigned a pressure space in which a fluid pressure correlated with a wheel load acting on the wheel prevails, with the associated pressure spaces of each diagonal wheel pair in each case being coupled to valve means, in such a manner that the valve means are actuated as a function of a pressure difference between the sum of the pressures in the pressure spaces of one diagonal wheel pair and the sum of the pressures in the pressure spaces of the other diagonal wheel pair and in the process connecting the pressure spaces which overall are at the higher pressure level to a low-pressure reservoir and the pressure spaces which are overall at the lower pressure level to a high-pressure source. When the axle load distribution is uneven, non-return valves are intended to prevent undefined changes in the position of the vehicle. Optimum control of the valves during this compensation operation is extremely difficult, since the pressure in the pressure spaces is constantly changing considerably on account of the fact that disturbance forces which fluctuate considerably are generally acting on the vehicle.

It is the object of the present invention to provide an improved method for adjusting and/or controlling an active and/or controllable chassis in a motor vehicle.

### SUMMARY OF THE INVENTION

In a method of controlling an active wheel suspension for a vehicle having a vehicle body that is supported by four vehicle wheels and a controllable suspension system, which includes displacement elements that can be set by a control unit, with sensors assigned to the control unit for determining spring travels and plunger positions, the control unit determines torsion constellations of the suspension system in which diagonally opposite vehicle wheels—in a compression stage—are on average at a shorter distance from the vehicle body than the wheels on the other diagonal—the rebound diagonal—and compensates for these torsion constellations by at least one of retracting the displacement elements on the compression diagonal and extending the displacement elements on the rebound diagonal.

In torsion constellations in which the vehicle wheels located opposite one another on a first diagonal—the compression diagonal—are on average at a shorter distance from the vehicle body than the wheels on the other diagonal—the rebound diagonal—the control unit compensates for the difference by retracting the plungers on the compression diagonal and/or extending the plungers on the rebound diagonal. The lifting displacements of the plunger which are performed in a torsion constellation can be readily matched to the extent of the torsion constellation, even when high external forces are acting on the vehicle.

This results in important advantages compared to vehicles with conventional suspension. In conventional vehicles, the active and/or controllable chassis attempts to “smooth out” unevenness in a roadway, which leads to higher wheel loads. By contrast, the solution according to the invention, by acting similarly to “off-road logic” minimizes the wheel load differences if the four wheel resting points are not all in one plane, thereby reducing the stress on the vehicle body.

In particular, the retracting and/or extending movements described reduce the dynamic wheel loads, thereby protecting components, such as for example axle components and expansion hoses. Moreover, in addition to driving safety, the ride comfort is also improved, since reduced wheel load changes inevitably reduce unpleasant body accelerations.

Furthermore, intervention by a traction control system is delayed by the leveling out of the wheel loads, with the result that the vehicle wheels in principle lift off an uneven roadway at a later time, thereby achieving improved traction. It is particularly advantageous in this context that this function can be performed by sensor means which are already installed in the vehicles, and consequently does not generate any additional production costs.

In addition to the above-described advantages, during a normal operating state, it is also possible to improve the handling of the vehicle in the event of a failure situation by means of the solution according to the invention. In modern passenger cars, full spare wheels are often only an optional extra, and, instead, only smaller emergency wheels are provided. The solution according to the invention minimizes the wheel load differences, so that the emergency wheel also receives an appropriate wheel load, and consequently the vehicle is more stable to drive.

In principle, the invention also improves the robustness of the chassis. For example, if an offset error arises in a spring travel sensor in the case of conventional chassis, this error, without the property of the invention (that of minimizing the wheel load differences) inevitably leads to permanent wheel load/spring travel differences, even when driving straight ahead. The solution according to the invention minimizes the wheel load differences in the event of an offset error in the spring travel sensor, i.e. in physical terms the correct spring travels (with respect to the wheel loads) are set and consequently the robustness of the system is increased.

A particularly expedient configuration of the invention is characterized in that the control unit compensates for a torsion constellation which has been determined in the vehicle predominantly by extending the plungers on the rebound diagonal. This allows the vehicle overall to have a greater ground clearance, which proves advantageous in particular on uneven terrain. At the same time, this makes it possible to increase the off-road ability of vehicles which otherwise have little ability to drive off road and to reduce the stress on the vehicle body.

A further advantageous configuration of the invention is characterized in that the control unit compensates for a torsion constellation determined in the vehicle predominantly by retracting the plungers on the compression diagonal. To increase the driving safety at relatively high speeds, it is expedient for the center of gravity of the vehicle to be arranged as low as possible. If torsion of the vehicle is counteracted predominantly by the retraction of the plungers on the compression diagonal, the vehicle body is brought closer to the ground, and consequently the center of gravity of the vehicle is automatically shifted downward.

Further important features and advantages of the invention will emerge from the sub-claims, from the drawings and from the associated descriptions of figures on the basis of the drawings.

An exemplary embodiment of the invention is illustrated in the drawings and explained in more detail in the descriptions which follow, in which similar or functionally equivalent components are designated by the same reference numerals.

### BRIEF DESCRIPTION OF THE DRAWINGS

FIG. 1 diagrammatically depicts a sketch of a chassis a cording to the invention on a torsional plane, and

FIG. 2 diagrammatically depicts a detail of a suspension system.

### DESCRIPTION OF AN EXEMPLARY EMBODIMENT

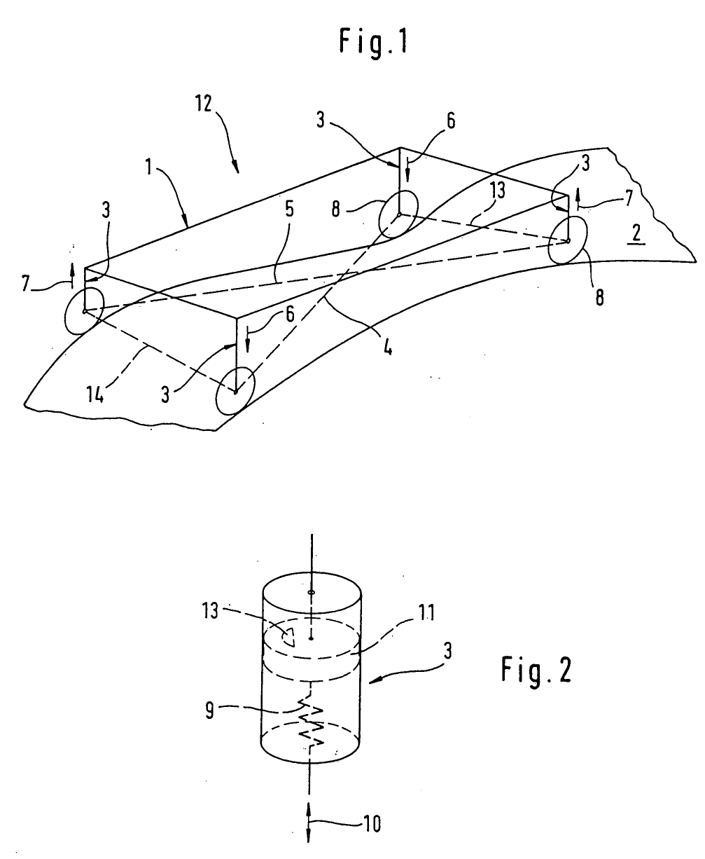

In accordance with FIG. 1, a vehicle 12 has a vehicle body 1 supported by four vehicle wheels 8. The vehicle wheels 8 are mounted to the vehicle body 1 in a known way by an adjustable suspension system 3. Along a load axis 10 (cf. FIG. 2), the suspension system 3 can be extended in the rebound direction 6 and retracted in the compression direction 7. In the event of the adjustable suspension system 3 moving in the rebound direction 6, the distance between the vehicle wheel 8 and the vehicle body 1 is increased, whereas in the event of the suspension system 3 moving in the compression direction 7, the distance between the vehicle wheel 8 and the vehicle body 1 is reduced. In this context, a compression or rebound movement is possible for each vehicle wheel 8 or suspension system 3, irrespective of the particular position of the other vehicle wheels 8 or suspension systems 3. As a result, contact between the vehicle wheels 8 and the ground can be ensured even on uneven terrain 2 as illustrated in FIG. 1, thereby ensuring improved traction.

As shown in FIG. 2, the adjustable suspension system 3 includes passive spring elements 9, which are in each case fitted between a vehicle wheel 8 and the vehicle body 1, and hydraulic displacement units, which are assigned to the spring elements 9 in series and comprise plungers/displacement elements 11 that can be set by a control unit 13. The control unit 13 can influence the position of the plunger 11 and therefore the position of the suspension system 3. The control unit 13 can displace the plunger 11 in the rebound direction 6 and compression direction 7 along the load axis 10.

In accordance with FIG. 1, the uneven terrain 2 is such that the respectively diagonally opposite vehicle wheels 8 move either in the rebound direction 6 or in the compression direction 7. One set of diagonally opposite vehicle wheels 8, which move in the rebound direction 6, are connected by a rebound diagonal 4, while the other vehicle wheels 8, which move in the compression direction 7, are connected by a compression diagonal 5.

The vehicle wheels 8 located on the compression diagonal 4, in accordance with FIG. 1, are on average at a shorter distance from the vehicle body 1 than the vehicle wheels 8 located on the rebound diagonal 5.

The control unit 13 (not shown in FIG. 1) compensates for the retraction of the plungers 11 on the compression diagonal 5 and/or the extension of the plungers 11 on the rebound diagonal 4, with the result that even on uneven terrain 2, illustrated as a twisting roadway in FIG. 1, the traction is improved and the stress on the vehicle body 1 is reduced.

In principle, there are three possible ways of control- ling the suspension systems 3. In the first of these, the control unit 13 compensates for a torsion constellation which is determined in the vehicle 12 predominantly by extending the plungers 11 in the rebound direction 6 on the rebound diagonal 4. The result of this is that the stress on the vehicle body 1 is reduced and the distance between the ground 2 and the vehicle body 1 is increased, thereby improving the off-road mobility of the vehicle 12.

In the second variant, the control unit 13 compensates for the torsion constellation determined in the vehicle 12 predominantly by retracting the plungers 11 along the compression direction 7 on the compression diagonal 5. The result of this is that the distance between the ground 2 and the vehicle body 1 is reduced, and therefore the center of gravity of the vehicle 12 as a whole is lowered, which is advantageous in particular in the event of minor unevenness and at relatively high driving speeds. Moreover, this also reduces the stress on the vehicle body 1.

In the third variant, the control unit 13 compensates for the torsion constellation determined in the vehicle 12 in approximately equal parts by retracting the plungers 11 on the compression diagonal 5 and extending the plungers 11 on the rebound diagonal 4. This results in a combination of the advantages described above.

Depending on the configuration of the terrain 2, the rebound diagonal 4 can also become the compression diagonal 5, and vice versa.

In a neutral position (not shown in FIG. 1) of the vehicle 12, all the vehicle wheels 8 are at the same distance from the vehicle body 1, and both wheel pair diagonals 4, 5 run parallel to the vehicle body 1 outlined in FIG. 1.

To control and/or adjust the active and/or controllable chassis, the control unit 13 determines a pre-definable desired plunger position or desired plunger movements/velocities to compensate for level, pitch and roll movements of the vehicle 12 by comparing them with actual values which are in each case present. Then, the method is realized on the basis of a continuous calculation of desired plunger positions/velocities on the basis of level/pitch/roll errors and a boundary condition “even-uneven” roadway.

The determination presupposes an at least approximately equal track width at a rear axle 13 and a front axle 14 of the vehicle 12, and the sign convention is such that the wheel-based plunger and spring travels are defined as positive in the rebound direction 6.

First of all, in a first step desired spring travels are calculated from individual adjustment components. In this context, a relationship is provided in each case for the difference between a desired level and an actual level (a), a desired pitch angle and an actual pitch angle (b) and a desired roll angle and an actual roll angle (c).
4·(Desired_level−actual_level)=FS1+FS2+FS3+FS4−F1−F2−F3−F4 (a)
2·(Desired_pitch_angle−actual_pitch_angle)=FS1+FS2−FS3−FS4−F1−F2+F3+F4 (b)
2·(Desired_roll_angle−actual_roll_angle)=FS1−FS2+FS3−FS4−F1+F2−F3+F4 (c)
0=FS1−FS2−FS3+FS4−F1+F2+F3−F4 (d)

The last relationship (d) represents a boundary condition relating to the uneven roadway 2. The definition of the desired plunger travels is determined from:
4·(Desired_level−actual_level)=PS1+PS2+PS3+PS4−P1−P2−P3−P4 (e)
2·(Desired_pitch_angle−actual_pitch_angle)=PS1+PS2−PS3−PS4−P1−P2+P3+P4 (f)
2·(Desired_roll_angle−actual_roll_angle)=PS1−PS2+PS3−PS4−P1+P2−P3+P4 (g)
K1·(FS1−FS2−PS1+PS2)=K2·(FS3−FS4−PS3+PS4) (h)

Relation (h) in this context produces the link to the first four relationships (a-d) and determines the rolling moment distribution which is established. By introducing the first four relationships (a-d) into the second four relationships (e-h) and eliminating the desired spring travels (FS) it is possible to obtain the desired plunger positions (PS), or alternatively the plunger positions resolved (PS-P) according to desired plunger travel changes as a function of a control deviation, the spring travels (F) and a wheel-based spring stiffness of the front axle 14 (K1) and a wheel-based spring stiffness of the rear axis 13 (K2).

The advantage of the solution illustrated is that all the adjustment components result in direct desired values. There is no superimposing. Dynamic influences of individual adjustment components, e.g. slow level/pitch angle correction, rapid roll angle/unevenness correction, is still possible as hitherto and can be achieved by separate filtering of the adjustment differences.

With the method described, it is possible to determine the desired plunger positions from the given actual spring travels and the actual plunger positions and thereby to adjust the active and/or controllable chassis. The wheel load differences which occur are minimized if the four wheel resting points do not all lie in one plane, thereby reducing the stress on the vehicle. In addition to the steady and dynamic wheel loads being reduced, traction control interventions are delayed as a result of the wheel loads being evened out, with the result that when traveling on an uneven roadway the wheels in principle lift off later, thereby achieving improved traction. This is particularly advantageous since this function can be executed using the sensor means which are already present in the vehicles. The reduced wheel load differences also assign the emergency wheel an appropriate wheel load in the event of a failure situation, thereby making handling more stable.

1. A method of controlling an active wheel suspension of a vehicle (12), comprising:
a vehicle body (1) with four vehicle wheels (8), supported by the wheel suspension system
the suspension system including a passive spring element (9) between each wheel (8) of the vehicle (12) and the vehicle body (1), hydraulic displacement units, which include the spring elements (9) in series with displacement elements (11), which are movably disposed in the displacement units, a control unit (13), and
sensor means (13) for determining spring travels and plunger positions,
the control unit (13) determining torsion constellations of the suspension system (3) in which the vehicle wheels (8) which are arranged opposite one another on a first diagonal—the compression diagonal (5)—are disposed at a shorter distance from the vehicle body (1) than the wheels (8) on the other diagonal—the rebound diagonal (4)—and compensating for these torsion constellations by providing for at least one of retraction of the plungers (11) on the compression diagonal (5) and extension of the plungers on the rebound diagonal (4).

2. The method as claimed in claim 1, wherein the control unit (13) compensates for a torsion constellation which has been determined in the vehicle (12) predominantly by extending the plungers (11) on the rebound diagonal (5).

3. The method as claimed in claim 1, wherein the control unit (13) compensates for a torsion constellation determined in the vehicle (12) by retracting the plungers (11) on the compression diagonal (4).

4. The method as claimed in claim 1, wherein the control unit (13) compensates for a torsion constellation which has been determined in the vehicle (12) to an approximately equal extent by retracting the plungers (11) on the compression diagonal (5) and extending the plungers (11) on the rebound diagonal (4).

5. The method as claimed in claim 1, wherein a neutral position of the vehicle (12), in which all the wheels (8) are at the same distance from the vehicle body (1), is used as the desired position when compensating for a lift, pitch and roll constellation.

6. The method as claimed in claim 5, wherein a position which deviates from the neutral position toward the actual position is used as the desired position when compensating for a torsion constellation.

7. The method as claimed in claim 6, wherein deviations of the deviating position from the neutral position become larger as the difference between neutral position and actual position increases.
